(19) United States
(12) Patent Application Publication
(10) Pub. No.: US 2012/0094669 A1
(43) Pub. Date: Apr. 19, 2012

(54) MOBILE COMMUNICATION METHOD AND RADIO ACCESS NETWORK DEVICE

(75) Inventors: Wuri Andarmawanti Hapsari, Kanagawa (JP); Tadashi Uchiyama, Kanagawa (JP); Minami Ishii, Kanagawa (JP)

(73) Assignee: NTT DOCOMO, INC., Tokyo (JP)

(21) Appl. No.: 13/266,459

(22) PCT Filed: Apr. 19, 2010
(86) PCT No.: PCT/JP2010/056925

§ 371 Date: Dec. 12, 2011

(30) Foreign Application Priority Data
Apr. 27, 2009 (JP) 2009-108297

(51) Int. Cl. H04W 4/00

(52) U.S. Cl. 455/435.2

(57) ABSTRACT

A radio base station includes a step-A where a second radio access network device inside a second radio access network notifies a first radio access network device inside a first radio access network of access information comprising at least one of either load information or barring information. Step-B includes a mobile station on standby in a cell under the first radio access network device, upon moving to an area in which the cell under the first radio access network device and the cell under the second radio access network device overlap, transmits a communication initiation request signal to the first radio access network device. Step-C includes the first radio access network device decides regarding in which of the cell under the first radio access network device or the cell under the second radio access network device. The communication of the mobile station should be initiated based on the access information.

### BACKGROUND OF INVENTION

1. Technical Field

The present invention relates to a mobile communication method and a radio access network device.

2. Background Art

A description will be provided with reference to FIG. 19 for the outgoing call processing of the mobile station UE in a conventional mobile communication system including E-UTRAN (Evolved-UTRAN) and UTRAN (Universal Terrestrial Radio Access Network).

As illustrated in FIG. 19, when the mobile station UE on standby in a cell in UTRAN (a cell under the radio network controller RNC (that is, the radio base station NodeB) in UTRAN) in step 2 moves in step 3 to an area in which the cell in UTRA and a cell in E-UTRAN (a cell under the radio base station eNB in UTRAN) overlap geographically and then sends “RRC Connection Request (communication initiation signal)” to the radio network controller RNC in order to initiate PS (Packet Switched) communication in step 4, the radio network controller RNC sends in step 5 “RRC Connection Reject” containing “Redirection Info (re-connection instruction signal)” indicating that the PS communication should be initiated in the cell in E-UTRAN to the mobile station UE.

In the 3GPP, the operation of the radio network controller RNC is called “First Redirection”.

However, in a conventional mobile communication system, the radio network controller RNC has had the potential to fail to initiate the PS communication of the mobile station UE by carrying out the “First Redirection” for a cell in a congested E-UTRAN or for a cell in E-UTRAN in which communication has been restricted.

### SUMMARY OF INVENTION

One or more embodiments of the present invention may provide a mobile communication method and a radio access network device in such that it is possible to appropriately select a radio access network for initiating the communication of the mobile station in a mobile communication system including a plurality of types of radio access networks.

The first feature of the present invention is summarized in that a mobile communication method, comprising a step A in which a second radio access network device inside a second radio access network notifies a first radio access network device inside a first radio access network of access information comprising at least one of either load information in the second radio access network device or barring information regarding the cell under the second radio access network device, a step B in which a mobile station on standby in a cell under the first radio access network device, upon moving to an area in which the cell under the first radio access network device and the cell under the second radio access network device overlap, transmits a communication initiation request signal to the first radio access network device and a step C in which the first radio access network device decides regarding in which of the cell under the first radio access network device or the cell under the second radio access network device, the communication of the mobile station should be initiated based on the access information.

The second feature of the present invention is summarized in that a radio access network device functioning as a second radio access network device inside a second radio access network, comprising a notification unit configured to notify the first radio access network device of the access information by transmitting the same to the mobile switching center that houses the second radio access network device, in a message for transferring specific information to a mobile switching center housing a first radio access network device inside a first radio access network contains access information comprising at least one of either load information in the second radio access network device or barring information regarding a cell under the second radio access network device.

The third feature of the present invention is summarized in that a radio access network device functioning as a first radio access network device inside a first radio access network, the device comprising, an acquisition unit configured to acquire, from a second radio access network device inside a second radio access network, access information comprising at least one of either load information in the second radio access network device or barring information regarding a cell under the second radio access network device and a decision unit configured such that when a mobile station on standby in a cell under the first radio access network device moves to an area in which the cell under the first radio access network device and a cell under the second radio access network device overlap, and sends a communication initiation request signal to the first radio access network device, a decision is made regarding in which of the cell under the first radio access network device or the cell under the second radio access network device, the communication of the mobile station should be initiated based on the access information.

As has been described above, according to the present invention, it is possible to provide a mobile communication method and a radio access network device such that it is possible to appropriately select a radio access network for initiating the communication of a mobile station in a mobile communication system including a plurality of types of radio access networks.

### BRIEF DESCRIPTION OF THE DRAWINGS

FIG. 1 is a diagram showing the entire configuration of the mobile communication system according to a first embodiment of the present invention.

FIG. 2 is a diagram to provide a description for a message sent and received within the mobile communication system according to the first embodiment of the present invention.

FIG. 3 is a table illustrating a format example of “eNB DIRECT INFORMATION TRANSFER” sent and received within the mobile communication system according to the first embodiment of the present invention.

FIG. 4 is a table illustrating an example of the information element “Inter-system Information Transfer Type” contained in “eNB DIRECT INFORMATION TRANSFER” sent and received within the mobile communication system according to the first embodiment of the present invention.

FIG. 5 is a table illustrating an example of the information element “E-UTRAN Access Info” contained in “eNB DIRECT INFORMATION TRANSFER” sent and received within the mobile communication system according to the first embodiment of the present invention.

FIG. 6 is a table illustrating an example of the information element “E-UTRAN Access Related Information” contained in “eNB DIRECT INFORMATION TRANSFER” sent and received within the mobile communication system according to the first embodiment of the present invention.

FIG. 7 is a table illustrating an example of the information element “E-UTRAN Routing Address” contained in “eNB DIRECT INFORMATION TRANSFER” sent and received within the mobile communication system according to the first embodiment of the present invention.

FIG. 8 is a table illustrating a format example of “DIRECT INFORMATION TRANSFER” sent and received within the mobile communication system according to the first embodiment of the present invention.

FIG. 9 is a table illustrating an example of the information element “Inter-system Information Transfer Type” contained in “DIRECT INFORMATION TRANSFER” sent and received within the mobile communication system according to the first embodiment of the present invention.

FIG. 10 is a table illustrating an example of “Redirection Info” contained in “RRC Connection Reject” sent and received within the mobile communication system according to the first embodiment of the present invention.

FIG. 11 is a table illustrating an example of the information element “Inter-RAT info” contained in “Redirection info” sent and received within the mobile communication system according to the first embodiment of the present invention.

FIG. 12 is a table illustrating an example of the information element “E-UTRA Target info” contained in the information element “Inter-RAT info” contained in “Redirection info” sent and received within the mobile communication system according to the first embodiment of the present invention.

FIG. 13 is a diagram showing the entire configuration of the mobile communication system according to a first embodiment of the present invention.

FIG. 14 is a diagram for providing a description for a message to be sent and received within the mobile communication system according to the first embodiment of the present invention.

FIG. 15 is a table illustrating an example of the information element “UTRAN Access Info” contained in “eNB DIRECT INFORMATION TRANSFER” sent and received within the mobile communication system according to the first embodiment of the present invention.

FIG. 16 is a table illustrating an example of the information element “UTRAN Access Related Information” contained in “eNB DIRECT INFORMATION TRANSFER” message sent and received within the mobile communication system according to the first embodiment of the present invention.

FIG. 17 is a table illustrating a format example of “MME DIRECT INFORMATION TRANSFER” message sent and received within the mobile communication system according to the first embodiment of the present invention.

FIG. 18 is a functional block diagram of the radio network controller and radio base station according to the first embodiment of the present invention.

FIG. 19 is a diagram showing the entire configuration of a convention mobile communication system.

### DETAILED DESCRIPTION

Mobile Communication System According to First Embodiment of the Present Invention

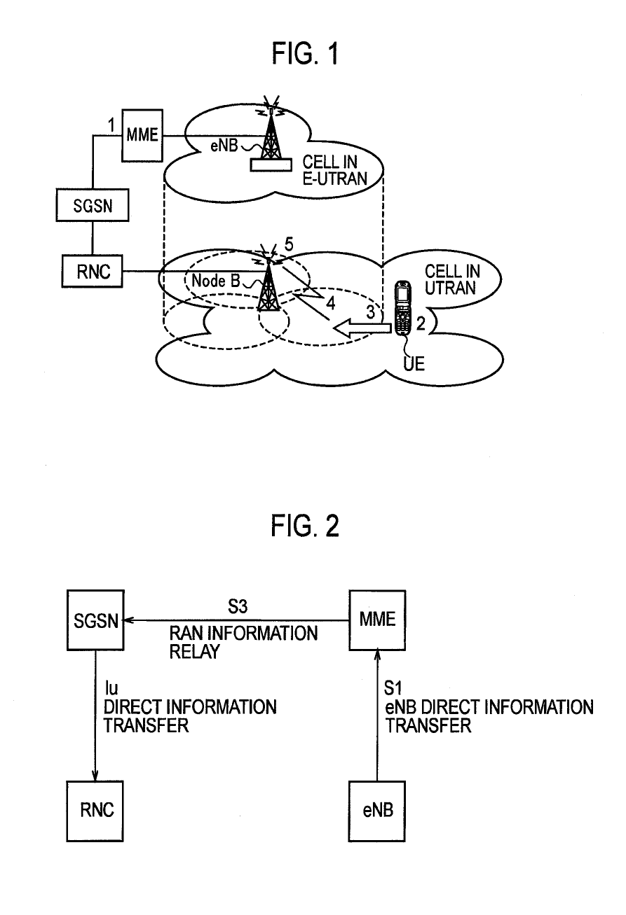

In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention. A description will be provided for the mobile communication system according to a first embodiment of the present invention, with reference to FIG. 1 to FIG. 17.

As illustrated in FIG. 1, the mobile communication system according to this embodiment has both E-UTRAN and UTRAN.

The mobile communication system according to this embodiment further includes a radio base station eNB, which is a radio access network device in E-UTRAN, a mobile switching center MME which accommodates the radio base station eNB, a radio network controller RNC and a radio base station NodeB, which are radio access network devices in UTRAN, and a mobile switching center SGSN which houses the radio network controller RNC.

Herein, a description will be provided for an example of outgoing call processing (initiation processing for PS communication) of the mobile station UE in the mobile communication system.

First, a description will be provided for an example of when the mobile station UE on standby in a cell in UTRAN initiates PS communication in a cell in E-UTRAN.

As illustrated in FIG. 1, in step 1, the radio base station eNB (the second radio access network device) notifies the radio network controller RNC (the first radio access network device) of “E-UTRAN Access Related Information (access information)” containing at least one of either the load information in the radio base station eNB or regulatory information regarding a cell under the radio base station eNB.

Specifically, as illustrated in FIG. 2, first, the radio base station eNB uses “eNB DIRECT INFORMATION TRANSFER” to send “EUTRAN Access Related Information” to the mobile switching center MME via an S1 interface; second, the mobile switching center MME uses “RAN INFORMATION RELAY” to transfer the “E-UTRAN Access Related Information” to the mobile switching center SGSN via an S3 interface; third, the mobile switching center. SGSN uses “DIRECT INFORMATION TRANSFER” to transfer the “E-UTRAN Access Related Information” to the radio network controller RNC via an Iu interface; and the radio base station eNB is thereby able to notify the radio network controller RNC of the “E-UTRAN Access Related Information”.

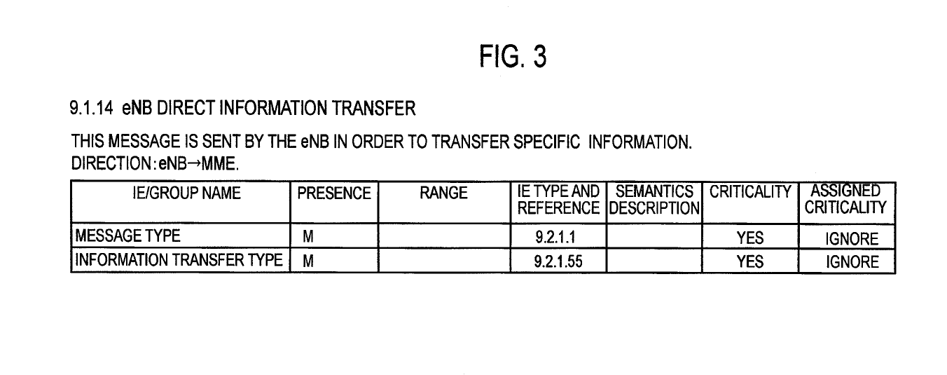

Herein, the “eNB DIRECT INFORMATION TRANSFER” is a message for transferring specific information from the radio base station eNB to the mobile switching center MME, and posses, for example, “Message Type” and “Information Transfer Type” as information elements (IE), as illustrated in FIG. 3.

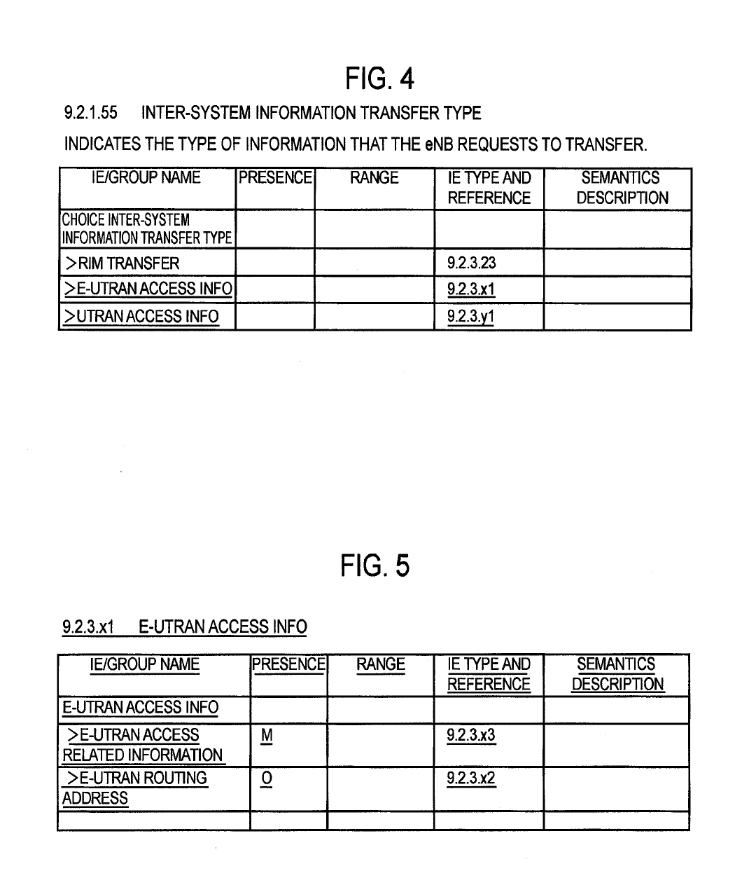

The “Message Type” is an information element defined in 9.2.1.1 of TS36.413 of the 3GPP, and the “Information Transfer Type” is an information element that contains any one of “RIM Transfer”, “E-UTRAN Access Info”, or “UTRAN Access Info” as information elements, as illustrated in FIG. 4.

In the case of FIG. 2, the “Information Transfer Type” contains “E-UTRAN Access Info” as an information element.

The “E-UTRAN Access Info”, as illustrated in FIG. 5, possesses “E-UTRAN Access Related Information” and “E-UTRAN Routing Address” as information elements.

Note that the “RIM Transfer” is an information element defined by 9.2.3.23 of TS36.413 of the 3GPP. A description will be provided later for the “UTRAN Access Related Information”.

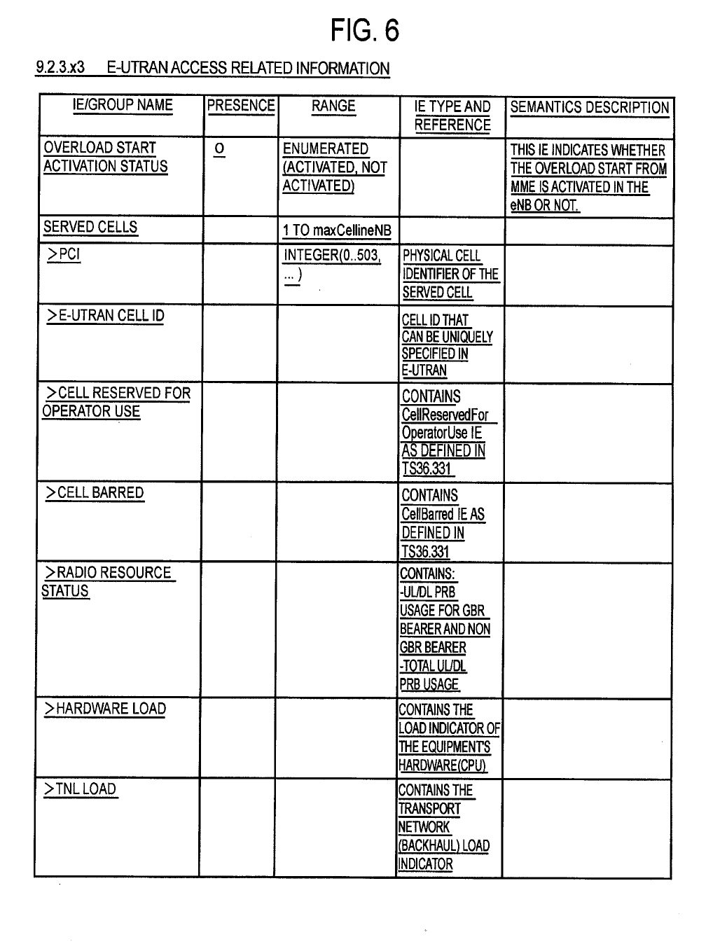

“E-UTRAN Access Related Information”, as illustrated in FIG. 6, possesses “Overload Start activation status” and “Served Cells” as information elements.

The “Overload Start activation status” is an information element indicating whether or not there has been an instruction to initiate an overload state for a radio access network device (in the example of FIG. 2, a radio base station eNB) that is the transmission source for the “eNB DIRECT INFORMATION TRANSFER” from the mobile switching center MME.

“Served Cells” is an information element capable of designating “PCI”, “E-UTRAN Cell ID”, “Cell Reserved for Operator Use”, “Cell Barred”, “Radio Resource Status”, “Hardware Load”, and “TNL Load”.

The “PCI” is information including the PCI (Physical Cell Identifier) of a cell capable of providing PS communication, and the “E-UTRAN Cell ID” is information including a cell ID that is uniquely identifiable in the E-UTRAN for a cell capable of providing PS communication.

The “Cell Reserved for Operator Use” is information defined by TS36.331 of the 3GPP, and is information (a type of regulatory information) including a list of cells to be used for an operator construction or for testing.

The “Cell Barred” is information defined by TS36.331 of the 3GPP, and is information (a type of regulatory information) including a list of cells under communication regulation.

The “Radio Resource Status” is information (a type of load information) containing the usage rate of the PRB (Physical Resource Block) in the downlink and uplink for the GBR bearer and non-GBR bearer, or the total usage rate and the like of the PRB in the downlink and uplink.

The “Hardware Load” is information (a type of load information) including an indicator indicating the load of hardware (for example, a CPU) of a radio access network device (in the example of FIG. 2, a radio base station eNB) that is the transmissions source of the “eNB DIRECT INFORMATION TRANSFER”.

The “TNL Load” is information (a type of load information) including an indicator indicating the load of a radio access network device (in the example of FIG. 2, a radio base station eNB) that is the transmission source of the transport network (“eNB DIRECT INFORMATION TRANSFER” and a core network device (in the example of FIG. 2, the transmission path with the mobile switching center MME).

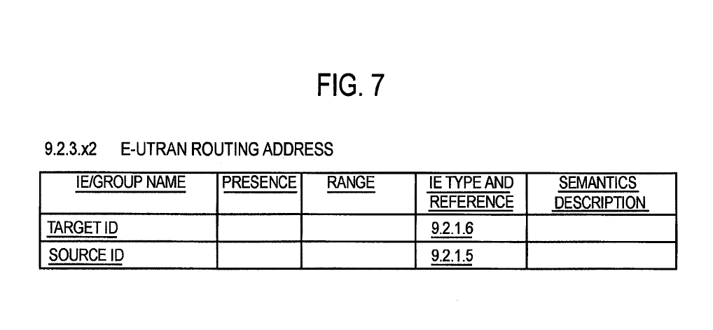

The “E-UTRAN Routing Address” also possesses “Target ID” and “Source ID” as information elements, as illustrated in FIG. 7. Herein, the “Target ID” is an information element defined by 9.2.1.6 of TS36.413 of the 3GPP, and the “Source ID” is an information element defined by 9.2.1.5 of TS36.413 of the 3GPP.

Also, the “RAN INFORMATION RELAY” is a message for transferring the “eNB DIRECT INFORMATION TRANSFER” from the radio base station eNB to the mobile switching center MME.

Furthermore, the “DIRECT INFORMATION TRANSFER” is a message of transferring specific information from the mobile switching center SGSN to the radio network controller RNC, and is a message of transferring specific information from the radio network controller RNC to the mobile switching center SGSN.

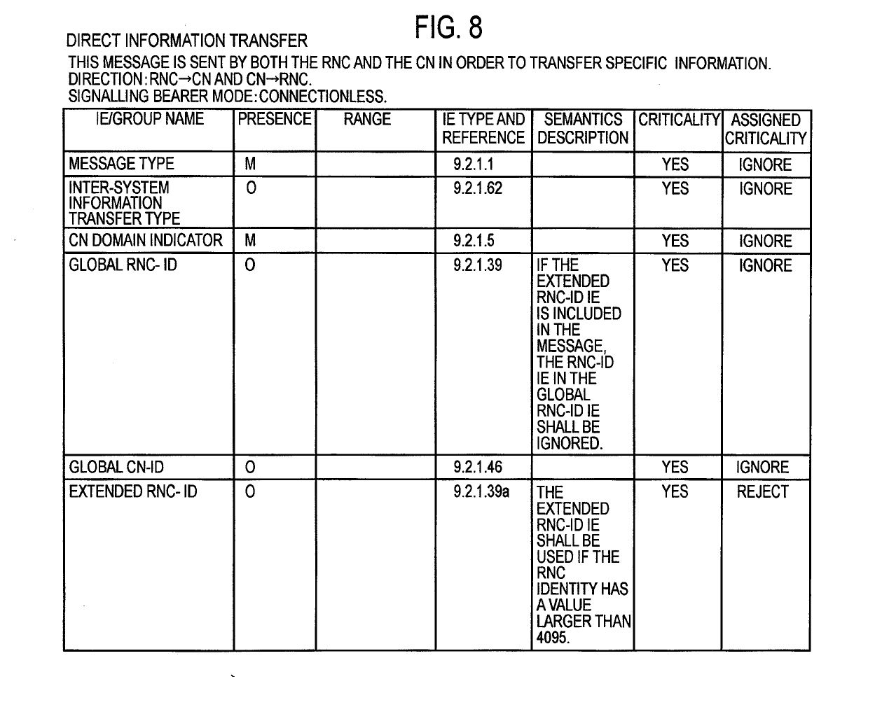

For example, the “DIRECT INFORMATION TRANSFER” possesses “Message Type”, “Inter-system Information Transfer Type”, “CN Domain Indicator”, “Global RNC-ID”, “Global CN-ID” and “Extended RNC-ID” as information elements (IE), as illustrated in FIG. 8.

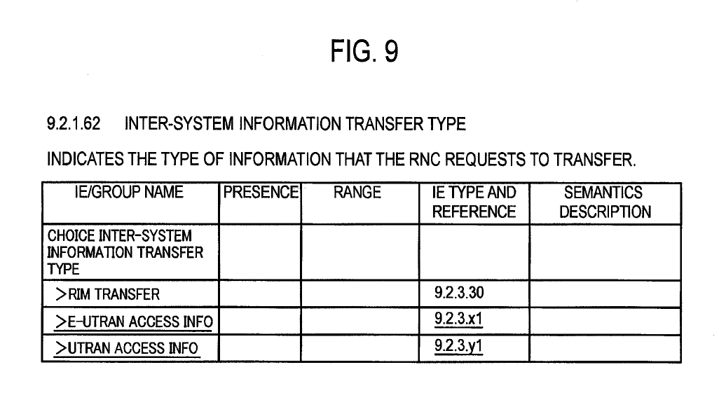

The “Inter-system Information Transfer Type” is an information element containing any one of the “RIM Transfer”, “E-UTRAN Access Info”, or “UTRAN Access Info” as an information element as illustrated in FIG. 9.

In the case of FIG. 2, the “Inter-system Information Transfer Type” contains “E-UTRAN Access Info” as the information element.

Herein, the configuration of the “E-UTRAN Access Info” is identical to the configuration of FIG. 5 to FIG. 7.

Also, the “Message Type” is an information element defined by 9.2.1.1 of TS25.413 of the 3GPP, the “CN Domain Indicator” is an information element defined by 9.2.1.5 of TS25.413 of the 3GPP, the “Global RNC-ID” is an information element defined by 9.2.1.39 of TS25.413 of the 3GPP, the “Global CN-ID” is an information element defined by 9.2.1.4.6 of TS25.413 of the 3GPP, and the “Extended RNC-ID” is an information element defined by 9.2.1.39a of TS25.413 of the 3GPP.

The mobile station UE on standby in a cell in UTRAN in step 2 moves in step 3 to an area in which a cell in UTRAN and a cell in E-UTRAN overlap geographically, and in step 4 sends “RRC Connection Request (communication initiation signal)” to the radio network controller RNC in order to initiate PS communication.

In step 5, the radio network controller RNC decides regarding in which of the cell under the radio network controller RNC or the cell under radio base station eNB, the communication of the mobile station UE should be initiated based on the “E-UTRAN Access Related Information”.

Herein, when a decision has been made that the PS communication of the mobile station UE should be initiated in the cell under the radio base station eNB—that is, when a decision has been made that “First Redirection” should be performed to the cell under the radio base station eNB, then the radio network controller RNC sends “RRC Connection Reject” containing “Redirection Info (re-connection instruction signals)” to the mobile station UE indicating this intention.

For example, the “Redirection Info” contains either “Frequency info” or “Inter-RAT info” as an information element.

The “Frequency info” is an information element defined by 10.3.6.36 of TS36.331 of the 3GPP, and the “Inter-RAT info” is an information element defined by 10.3.7.25 of TS36.331 of the 3GPP.

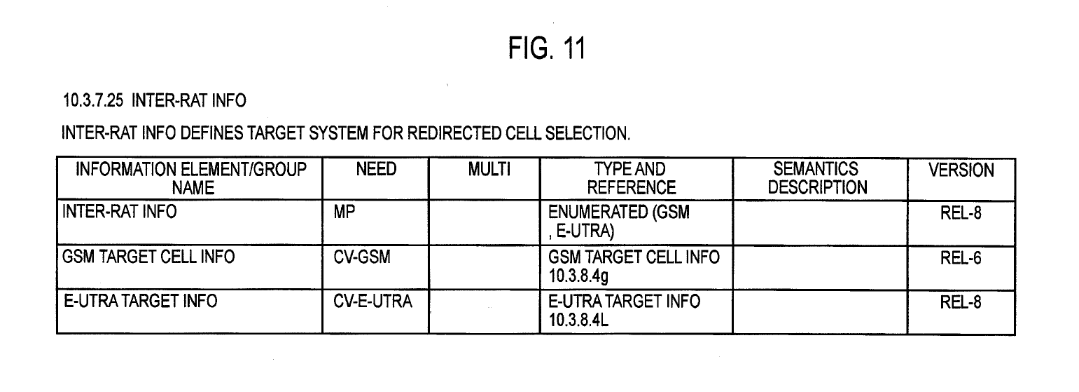

For example, the “Inter-RAT info” is an information element containing “GSM target cell info” and “E-UTRA target info” as information elements, as illustrated in FIG. 11.

The “GSM target cell info” is an information element that is set when the “GSM format” is selected as the target RAT (Radio Access Technology) of the “First Redirection”, and is an information element defined by 10.3.8.4g of TS36.331 of the 3GPP.

The “E-UTRA target info” is an information element that is set for when the “E-UTRA format” is selected as the target RAT of the “First Redirection”, and is an information element defined by 10.3.8.4L of TS36.331 of the 3GPP.

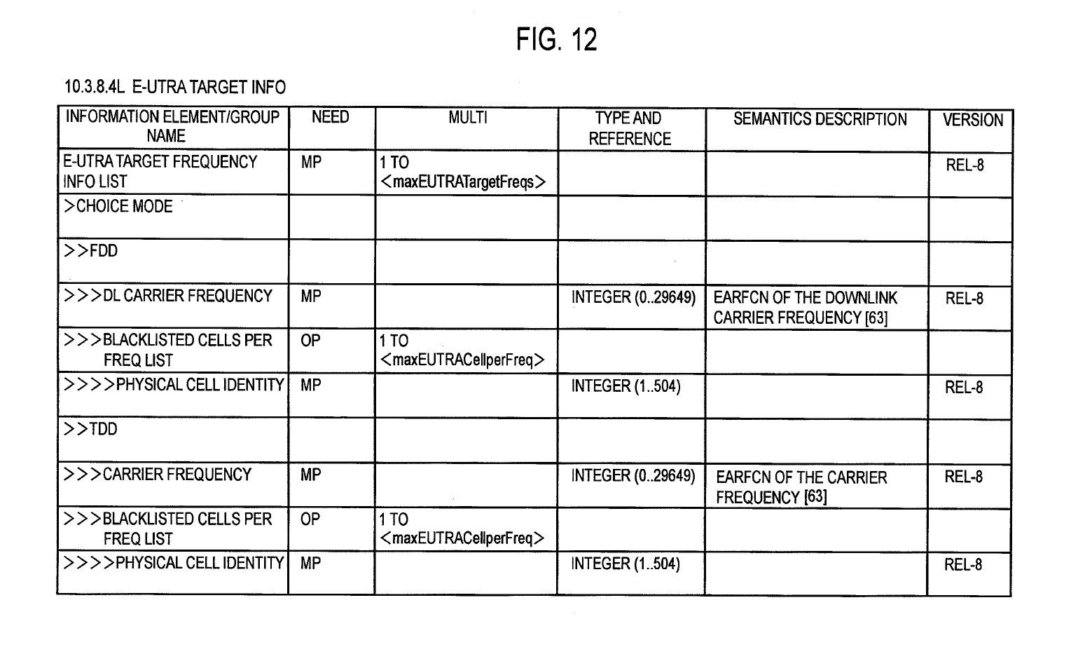

For example, as illustrated in FIG. 12, the “E-UTRA target info” possesses “E-UTRA Target Frequency Info List” as an information element.

For the “E-UTRA Target Frequency Info List”, it is possible to set “DL Carrier frequency”, “Blacklisted cells per freq list”, and “Physical Cell identity” in the FDD format, and it is possible set “Carrier frequency”, “Blacklisted cells per freq list”, and “Physical Cell identity” in the TDD format.

As a result, the mobile station UE, when “E-UTRA Target Frequency Info List” has been set in the received “Redirection Info”, selects the “E-UTRA format” as the target RAT of the “First Redirection”, and also selects a cell within the E-UTRAN based on the setting information inside the “E-UTRA Target Frequency Info List”, so as to then, by sending “RRC Connection Request” to the radio base station eNB, initiate PS communication within the cell in the E-UTRAN.

Secondly, a description will be provided for an example of when a mobile station UE on standby in a cell within E-UTRAN initiates PS communication in a cell within UTRAN.

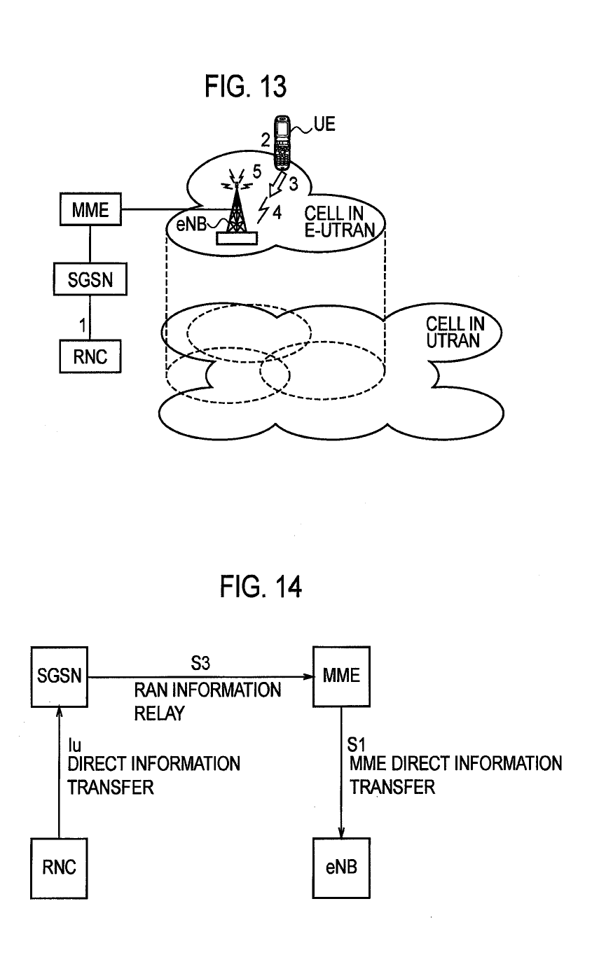

As illustrated in FIG. 13, in step 1, the radio network controller RNC (the second radio access network device) notifies the radio base station eNB (the first radio access network device) of “UTRAN Access Related Information (access information)” containing at least one of either load information in the radio network controller RNC or regulatory information regarding the cell under the radio network controller RNC.

Specifically, as illustrated in FIG. 14, first, the radio network controller RNC uses “DIRECT INFORMATION TRANSFER” to send “UTRAN Access Related Information” to the mobile switching center SGSN via an Iu interface; second, the mobile switching center SGSN uses “RAN INFORMATION RELAY” to transfer “UTRAN Access Related Information” to the mobile switching center MME via an S3 interface; third, the mobile switching center MME uses “MME DIRECT INFORMATION TRANSFER” to transfer “UTRAN Access Related Information” to the mobile base station eNB via an S1 interface; and the radio network controller RNC is thereby able to notify the radio base station eNB of the “UTRAN Access Related Information”.

Herein, the “DIRECT INFORMATION TRANSFER” is a message for transferring specific information from the radio network controller RNC to the mobile switching center SGSN, and possesses, for example, the information elements illustrated in FIG. 8.

In the case of FIG. 14, the “Inter-system Information Transfer Type”, which is an information element contained in the “DIRECT INFORMATION TRANSFER”, contains “UTRAN Access Info” as an information element (see FIG. 9).

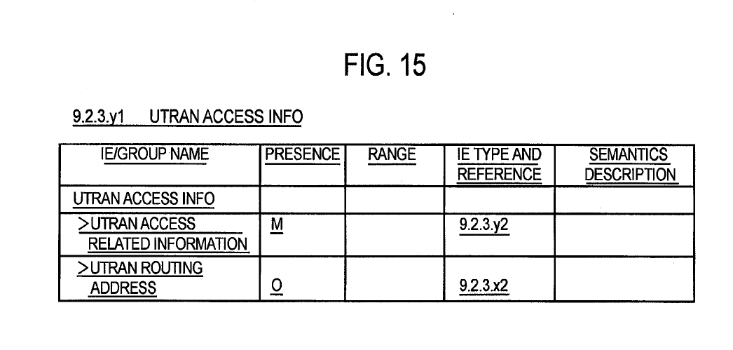

The “UTRAN Access Info”, as illustrated in FIG. 15, possesses “UTRAN Access Related Information” and “UTRAN Routing Address” as information elements.

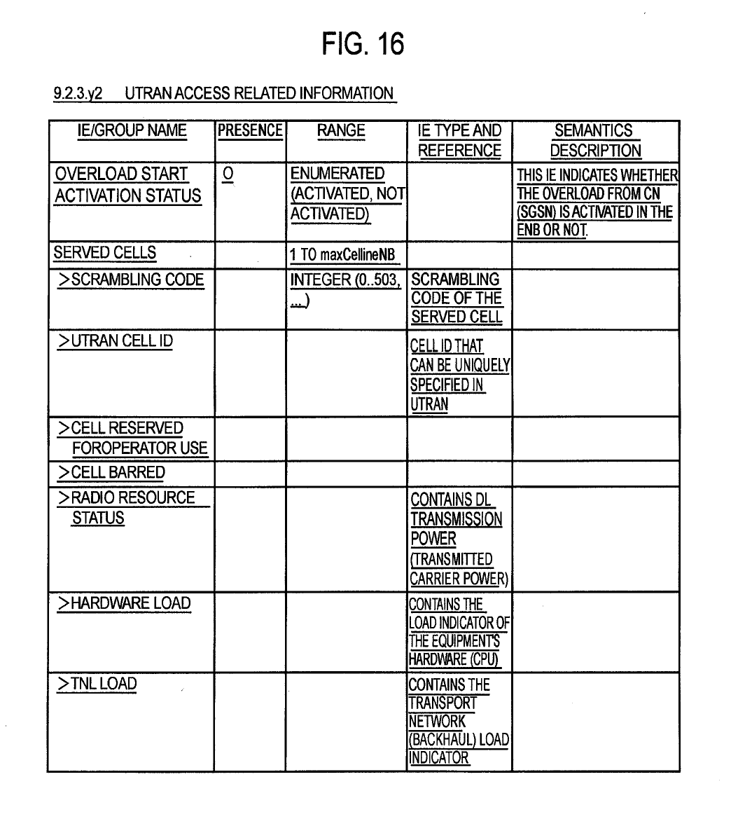

The “UTRAN Access Related Information”, as illustrated in FIG. 16, possesses “Overload Start activation status” and “Served Cells” as information elements.

The “Overload Start activation status” is an information element indicating whether or not there is an instruction to initiate an overload status for the radio access network device (in the example of FIG. 14, the radio network controller RNC) that is the transmission source of the “DIRECT INFORMATION TRANSFER” from the mobile switching center SGSN.

The “Served Cells” is an information element that can designate “Scrambling Code”, “UTRAN Cell ID”, “Cell Reserved For Operator Use”, “Cell Barred”, “Radio Resource Status”, “Hardware Load”, and “TNL Load”.

“Scrambling Code” is information that includes the scrambling code of a cell capable of providing PS communication, and the “UTRAN Cell ID” is information that contains a uniquely identifiable cell ID in the UTRAN for a cell capable of providing PS communication.

The “Cell Reserved For Operator Use” is information (a type of regulatory information) that includes a list of cells to be used in an operator construction or for testing.

The “Cell Barred” is information (a type of regulatory information) that includes a list of cells under communication regulation.

The “Radio Resource Status” is information (a type of load information) that includes the transmission power (power of the transmission carrier) in a downlink.

The “Hardware Load” is information (a type of load information) that includes an indicator indicating the load of hardware (for example, a CPU) of the radio access network device (in the example of FIG. 14, the radio network controller RNC) that is the transmission source of the “DIRECT INFORMATION TRANSFER”.

The “TNL Load” is information (a type of load information) that includes an indicator indicating the load of the radio access network device (in the example of FIG. 14, the radio network controller RNC) that is the transmissions source of the transport network (“DIRECT INFORMATION TRANSFER”, as well as that of a core network device (in the example of FIG. 14, the transmission path with the mobile switching center SGSN).

Furthermore, the “UTRAN Routing Address”, as illustrated in FIG. 7, possesses “Target ID” and “Source ID” as information elements. Herein, the “Target ID” is an information element defined by 9.2.1.6 of

TS36.413 of the 3GPP, and the “Source ID” is an information element defined by 9.2.1.5 of TS36.413 of the 3GPP.

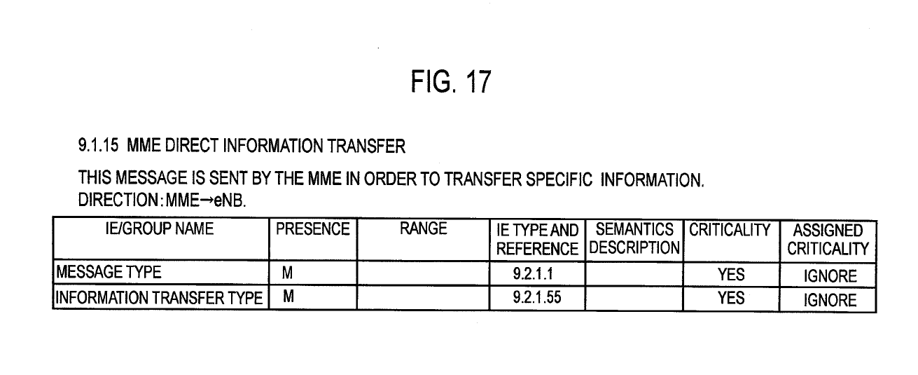

Also, the “MME DIRECT INFORMATION TRANSFER” is a message for transferring specific information from the mobile switching center MME to the radio base station eNB, and possesses, for example, as illustrated in FIG. 17, “Message Type” and “Information Transfer Type” as information elements.

The “Message Type” is an information element defined by 9.2.1.1 of TS36.413 of the 3GPP, the “Information transfer Type” includes the information elements illustrated in FIG. 4.

Note that in the case of FIG. 14, the “Inter-system Information Transfer Type”, which is an information element contained in the “MME DIRECT INFORMATION TRANSFER” contains “UTRAN Access Info” as an information element (see FIG. 4).

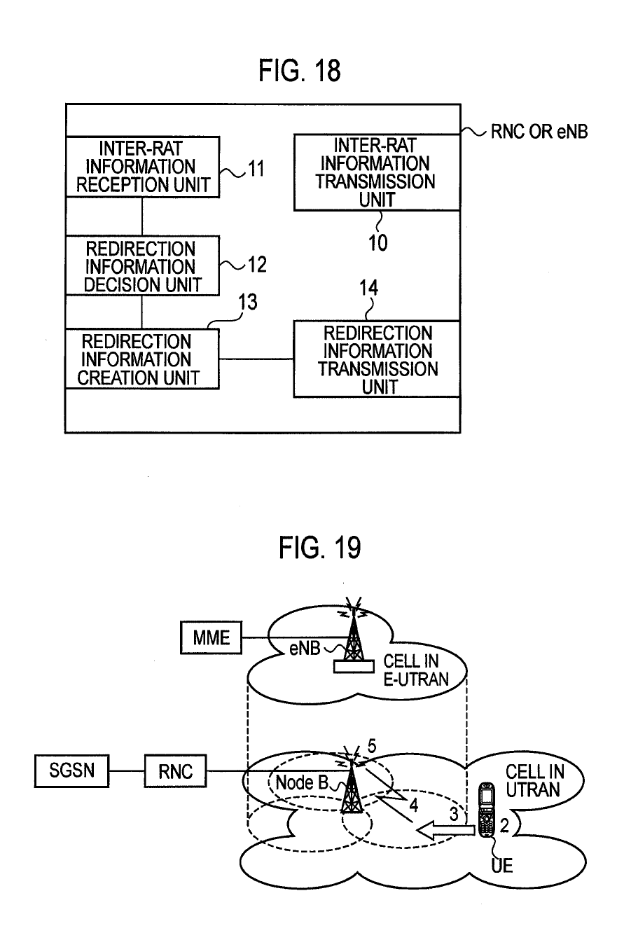

As illustrated in FIG. 18, the radio network controller RNC and the radio base station eNB according to this embodiment include an inter-RAT information transmission unit 10, an inter-RAT information reception unit 11, a redirection information decision unit 12, a redirection information creation unit 13, and a redirection information transmission unit 14.

In the radio network controller RNC, the inter-RAT information transmission unit 10, as described above, is configured to transmit “UTRAN Access Related Information” to the radio base station eNB.

Herein, the inter-RAT information transmission unit 10 may be configured to transmit the “UTRAN Access Related Information (load information or regulatory information)” whenever there has been a change to the “UTRAN Access Related Information” or alternatively whenever there is a request from the radio base station eNB.

On the other hand, in the radio base station eNB, the inter-RAT information transmission unit 10, as described above, is configured to send “E-UTRAN Access Related Information” to the radio network controller RNC.

Herein, the inter-RAT information transmission unit 10 may be configured to transmit the “E-UTRAN Access Related Information (load information or regulatory information)” whenever there has been a change to the “E-UTRAN Access Related Information”, or alternatively whenever there is a request from the radio network controller RNC.

In the radio network controller RNC, the inter-RAT information reception unit 11, as described above, is configured to receive the “E-UTRAN Access Related Information” from the radio base station eNB.

On the other hand, in the radio base station eNB, the inter-RAT information reception unit 11, as described above, is configured to receive the “UTRAN Access Related Information” from the radio network controller RNC.

In the radio network controller RNC, the redirection information decision unit 12 is configured such that, when the mobile station UE on standby in a cell under the radio network control unit

RNC moves to an area in which the cell under the radio network control unit RNC and a cell under the radio base station eNB overlap and transmits “RRC connection Request” to the radio network controller RNC, a decision is made regarding in which of the cell under the radio network controller RNC or the cell under the radio base station eNB, the communication of the mobile station UE should be initiated, based on the “E-UTRAN Access Related Information” as received by the inter-RAT information reception unit 11.

On the other hand, in the radio base station eNB, the redirection information decision unit 12 is configured such that when the mobile station UE on standby in a cell under the radio base station eNB moves to an area in which the cell under the radio base station eNB and a cell under the radio network controller RNC overlap and transmits “RRC Connection Request” to the radio base station eNB, a decision is made regarding in which of the cell under the radio network controller RNC or the cell under the radio base station eNB, the communication of the mobile station UE should be initiated, based on the “UTRAN Access Related Information” as received by the inter-RAT information reception unit 11.

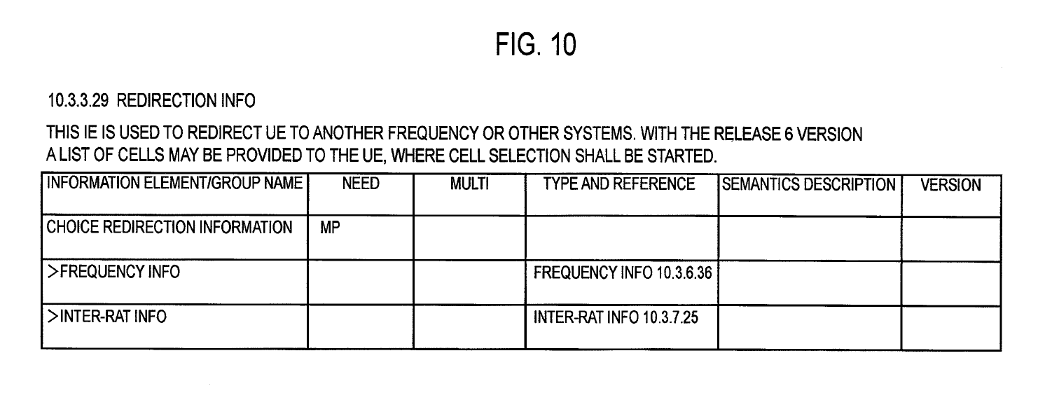

In the radio network controller RNC, when the redirection information decision unit 12, as described above, has decided that the communication of the mobile station UE should be initiated in the cell under the radio base station eNB, the redirection information creation unit 13 is configured to produce “Redirection Info” (see FIG. 10 to FIG. 12) indicating this intention, and the redirection information transmission unit 14 is configured to transmit “RRC Connection Reject” containing the “Redirection Info” to the mobile station UE.

In the radio base station eNB, when the redirection information decision unit 12, as described above, has decided that the communication of the mobile station UE should be initiated in the cell under the radio network controller RNC, the redirection information creation unit 13 is configured to produce “Redirection Info (see FIG. 10 to FIG. 12)” indicating this intention, and the redirection information transmission unit 14 is configured to transmit “RRC Connection Reject” containing the “Redirection Info” to the mobile station UE.

According to the mobile communication system according to the first embodiment of the present invention, a first radio access network device (for example, a radio network controller RNC or a radio base station eNB) is able to acquire access information in a second radio access network device from the second radio access network device (for example, a radio base station eNB or a radio network controller RNC) such that an appropriate selection can be made for the cell or RAT used to initiate the communication of the mobile station UE based on the access information.

Characteristics of this embodiment as described above may be represented as follows.

A first characteristic of this embodiment is summarized in that a mobile communication method has a step A in which a radio base station eNB (a second radio access network device) inside E-UTRAN (the second radio access network) notifies a radio network controller RNC (a first radio access network device) inside UTRAN (the first radio access network) of “E-UTRAN Access Related Information (access information)” containing at least one of either load information in the radio base station eNB or regulatory information regarding a cell under the radio base station eNB, a step B in which a mobile station UE on standby in a cell under the radio network controller RNC transmits “RRC Connection Request (communication initiation request signal)” to the radio network controller RNC upon moving to an area in which a cell under the radio network controller RNC and a cell under the radio base station eNB overlap, and a step C in which the radio network controller RNC makes a decision regarding in which of the cell under the radio network controller RNC or the cell under the radio base station eNB, the communication of the mobile station UE should be initiated, based on the “E-UTRAN Access Related Information”.

In the first characteristic of this embodiment, when the radio network controller RNC decides in step C that the communication of the mobile station UE should be initiated in the cell under the radio base station eNB, there may further be a step D in which “Redirection Info (re-connection instruction signal)” indicating this intention is transmitted to the mobile station UE.

In the first characteristic of this embodiment, the step A may include a step in which the radio base station eNB transmits “E-UTRAN Access Related Information” to the mobile switching center MME that houses the radio base station eNB, a step in which the mobile switching center MME transfers the “E-UTRAN Access Related Information” to the mobile switching center SGSN that houses the radio network controller RNC, and a step in which the mobile switching center SGSN transfers the “E-UTRAN Access Related Information” to the radio network controller RNC.

In the first characteristic of this embodiment, when there is a change to the load information or regulatory information mentioned above or when there is a request from the radio network controller RNC in the step A, the radio base station eNB may notify the radio network controller RNC of the “E-UTRAN Access Related Information” containing the load information or regulatory information.

A second characteristic of this embodiment is summarized in that there is a step A in which a radio network controller RNC (a second radio access network device) inside UTRAN (the second radio access network device) notifies a radio base station eNB (a first radio access network device) inside E-UTRAN (the first radio access network) of “UTRAN Access Related Information (access information)” containing at least one of either the load information in the radio network controller RNC or the regulatory information regarding a cell under the radio network controller RNC, a step B in which a mobile station UE on standby in a cell under the radio base station eNB transmits “RRC Connection Request (communication initiation request signal)” to the radio base station eNB upon moving to an area in which the cell under the radio base station eNB and the cell under the radio network controller RNC overlap, and a step C in which the radio base station eNB makes a decision regarding in which of the cell under the radio base station eNB or the cell under the radio network controller RNC, the communication of mobile station UE should be initiated based on the “UTRAN Access Related Information”.

In the second characteristic of this embodiment, when the radio base station eNB decides in step C that the communication of the mobile station UE should be initiated in the cell under the radio network controller RNC, there may further be a step D in which “Redirection Info (re-connection instruction signal)” indicating this intention is transmitted to the mobile station UE.

In the second characteristic of this embodiment, the step A may further include a step in which the radio network controller RNC transmits “UTRAN Access Related Information” to the mobile switching center SGSN that houses the radio network controller RNC, a step in which the mobile switching center SGSN transfers the “UTRAN Access Related Information” to the mobile switching center MME that houses the radio base station eNB, and a step in which the mobile switching center MME transfers the “UTRAN Access Related Information” to the radio base station eNB.

In the second characteristic of this embodiment, when there is a change to the load information or regulatory information mentioned above or when there is a request from the radio base station eNB in the step A, the radio network controller RNC may notify the radio base station eNB of the “UTRAN Access Related Information” containing the load information or regulatory information.

A third characteristic of this embodiment is summarized in that a radio base station eNB includes an inter-RAT information transmission unit 10 configured such that “eNB DIRECT INFORMATION TRANSFER (message)” for transferring specific information to the mobile switching center SGSN that houses the radio network controller RNC includes “E-UTRAN Access Related Information” containing at least one of either the load information in the radio base station eNB or the regulatory information regarding the cell under the radio base station eNB and is transmitted to a mobile switching center MME that houses the radio base station eNB, thus notifying the radio network controller RNC of the “E-UTRAN Access Related Information”.

In the third characteristic of this embodiment, the inter-RAT information transmission unit 10 may be configured to notify the radio network controller RNC of the “E-UTRAN Access Related Information” described above whenever there has been a change to the above-mentioned load information or regulatory information, or whenever there is a request from the radio network controller RNC.

A fourth characteristic of this embodiment is summarized in that a radio network controller RNC includes an inter-RAT information transmission unit 10 configured such that “DIRECT INFORMATION TRANSFER (message)” for transferring specific information to the mobile switching center MME that houses the radio base station eNB includes “UTRAN Access Related Information” containing at least one of either the load information in the radio network controller RNC or the regulatory information regarding the cell under the radio network controller RNC and is transmitted to a mobile switching center SGSN that houses the radio network controller RNC, thus notifying the radio base station eNB of the “UTRAN Access Related Information”.

In the fourth characteristic of this embodiment, the inter-RAT information transmission unit 10 may be configured to notify the radio base station eNB of the “UTRAN Access Related Information” described above whenever there has been a change to the load information or the regulatory information mentioned above, or whenever there is a request from the radio base station eNB.

A fifth characteristic of this embodiment is summarized in that a radio network controller RNC includes an inter-RAT information reception unit 11 configured to acquire “E-UTRAN Access Related Information” from the radio base station eNB including at least one of either the load information in the radio base station eNB or the regulatory information regarding the cell under the radio base station eNB, and a redirection information decision unit 12, configured such that whenever a mobile station UE on standby in a cell under the radio network controller RNC moves to an area in which the cell under the radio network controller RNC and the cell under the radio base station eNB overlap and sends “RRC Connection Request” to the radio network controller RNC, a decision is made regarding in which of the cell under the radio network controller RNC or the cell under the radio base station eNB, the communication of the mobile station UE should be initiated based on the “E-UTRAN Access Related Information”.

In the fifth characteristic of this embodiment, when the redirection information decision unit 12 decides that the communication of the mobile station UE should be initiated in the cell under the radio base station eNB, a redirection information transmission unit 14 configured to transmit “Redirection info” indicating this intention to the mobile station UE may be further included.

A sixth characteristic of this embodiment is summarized in that a radio base station eNB includes an inter-RAT information reception unit 11 configured to acquire “UTRAN Access Related Information” from the radio network controller RNC including at least one of either the load information in the radio network controller RNC or the regulatory information regarding the cell under the radio network controller RNC, and a redirection information decision unit 12, configured such that whenever a mobile station UE on standby in a cell under the radio base station eNB moves to an area in which the cell under the radio base station eNB and the cell under the radio network controller RNC overlap and sends “RRC Connection Request” to the radio base station eNB, a decision is made regarding in which of the cell under the radio base station eNB or the cell under the radio network controller RNC, the communication of the mobile station UE should be initiated based on the “UTRAN Access Related Information”.

In the sixth characteristic of this embodiment, when the redirection information decision unit 12 decides that the communication of the mobile station UE should be initiated in the cell under the radio network controller RNC, a redirection information transmission unit 14 configured to transmit “Redirection info” indicating this intention to the mobile station UE may be further included.

(Modification) Note that operation of the above described the mobile switching center MME/SGSN, the radio network controller RNC, the radio base station eNB and the mobile station UE may be implemented by means of hardware, a software module executed by a processor, or a combination of both.

The software module may be provided in any type of storage medium such as an RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can read and write information from and to the storage medium. Also, the storage medium may be integrated into the processor. Also, the storage medium and the processor may be provided in an ASIC. The ASIC may be provided in the mobile switching center MME/SGSN, the radio network controller RNC, the radio base station eNB and the mobile station UE. Also, the storage medium and the processor may be provided in the mobile switching center MME/SGSN, the radio network controller RNC, the radio base station eNB and the mobile station UE as a discrete component.

Hereinabove, the present invention has been described in detail using the above embodiment; however, it is apparent to those skilled in the art that the present invention is not limited to the embodiment described herein. Modifications and variations of the present invention can be made without departing from the spirit and scope of the present invention defined by the description of the scope of claims. Thus, what is described herein is for illustrative purpose, and has no intention whatsoever to limit the present invention.

1. A mobile communication method, comprising:
a step A in which a second radio access network device inside a second radio access network notifies a first radio access network device inside a first radio access network of access information comprising at least one of either load information in the second radio access network device or barring information regarding the cell under the second radio access network device;
a step B in which a mobile station on standby in a cell under the first radio access network device, upon moving to an area in which the cell under the first radio access network device and the cell under the second radio access network device overlap, transmits a communication initiation request signal to the first radio access network device; and
a step C in which the first radio access network device decides regarding in which of the cell under the first radio access network device or the cell under the second radio access network device, the communication of the mobile station should be initiated based on the access information.

2. The mobile communication method according to claim 1, further comprising:
a step D in which when it is decided in step C that the communication of the mobile station should be initiated in the cell under the second radio access network device, the first radio access network device transmits a re-connection instruction signal indicating this intention to the mobile station.

3. The mobile communication method according to claim 1, wherein
the step A comprises:
a step in which the second radio access network device sends the access information to a mobile switching center housing the second radio access network device;
a step in which the mobile switching center accommodating the second radio access network device transfers the access information to a mobile switching center housing the first radio access network device; and
a step in which the mobile switching center housing the first radio access network device transfers the access information to the first radio access network device.

4. The mobile communication method according to claim 1, wherein
in the step A, when there has been a change to the load information or to the barring information or when there is a request from the first radio access network device, the second radio access network device notifies the first radio access network device of the access information containing the load information or regulatory information.

5. A radio access network device functioning as a second radio access network device inside a second radio access network, comprising a notification unit configured to notify the first radio access network device about the access information by transmitting to the mobile switching center that houses the second radio access network device, in a message used for transferring specific information to a mobile switching center housing a first radio access network device inside a first radio access network contains access information comprising at least one of either load information in the second radio access network device or barring information regarding a cell under the second radio access network device.

6. The radio access network device according to claim 5, wherein
when there is a change to the load information or the regulatory information, or when there is a request from the first radio access network device, the notification unit is configured to notify the first radio access network device of access information comprising the load information or the regulatory information.

7. A radio access network device functioning as a first radio access network device inside a first radio access network, the device comprising:
an acquisition unit configured to acquire, from a second radio access network device inside a second radio access network, access information comprising at least one of either load information in the second radio access network device or barring information regarding a cell under the second radio access network device; and
a decision unit configured such that when a mobile station on standby in a cell under the first radio access network device moves to an area in which the cell under the first radio access network device and a cell under the second radio access network device overlap, and sends a communication initiation request signal to the first radio access network device, a decision is made regarding in which of the cell under the first radio access network device or the cell under the second radio access network device, the communication of the mobile station should be initiated based on the access information.

8. The radio access network device according to claim 7, wherein
when the decision unit decides that the communication of the mobile station should be initiated in the cell under the second radio access network device, a re-connection instruction signal transmission unit is further provided configured to transmit a re-connection instruction signal indicating this intention to the mobile station.
